(19) United States
(12) Patent Application Publication
(10) Pub. No.: US 2021/0398124 A1
(43) Pub. Date: Dec. 23, 2021

(54) SYSTEMS AND METHODS FOR MANAGING A TRANSACTION STATE OBJECT

(71) Applicant: Visa International Service Association, San Francisco, CA (US)

(72) Inventors: Gurpreet Singh Bhasin, Fremont, CA (US); Ghanshyam Rokde, Fremont, CA (US); Soorej Nair, San Jose, CA (US)

(21) Appl. No.: 17/291,587

(22) PCT Filed: Nov. 6, 2018
(86) PCT No.: PCT/US2018/059473

§ 371 Date: May 5, 2021

(51) Int. Cl. G06Q 20/40; G06Q 20/38

(52) U.S. Cl. CPC G06Q 20/4014; G06Q 20/3827; G06Q 20/3829; G06Q 20/4016

(57) ABSTRACT

A method is disclosed. A server computer receives, from a client computer, of a plurality of client computers, a transaction state object indicating that a transaction has been initiated. The server computer transmits, to a first subset of the client computers, a notification that the transaction has been initiated. The server computer receives, from a second client computer, a first modification to the transaction state object indicating that a first step has been executed. The server computer transmits, to a second subset of the client computers, a notification that the first step in the transaction has been executed. The server computer receives, from a third client computer, a second modification to the transaction state object indicating that a second step in the transaction has been executed. The server computer transmits, to a third subset of the client computers, a notification that the second step has been executed.

### CROSS-REFERENCES TO RELATED APPLICATIONS

None.

### BACKGROUND

A transaction may involve multiple entities, each performing one or more steps in the transaction. As an example, in a payment transaction, a merchant may initiate the transaction, an issuer may authorize the transaction, and an acquirer may fund the transaction. As another example, in a transaction to license a song, the song owner and licensee may work out contract terms through a series of proposals, finalize a contract, sign the contract, and arrange payment.

To determine the status of a transaction at a given time, the entities typically must send messages to one another. For example, in a payment transaction, a merchant may send an authorization request message, which is forwarded and processed by several entities. The merchant will eventually receive an authorization response message, which is likewise forwarded and processed by several entities before reaching the merchant. The transaction may include additional steps such as capture, funding, and authentication, each of which may include its own set of request and response messages. As the transaction is processed, the status of the transaction may proceed from a pre-authorization phase to an authorization phase and so forth.

At a given time, each of the entities may have a disjointed view of the present transaction status, based on the latest message received. Each entity may categorize the transaction status at a given time in a way that does not necessarily align with the transaction status categorized by a different entity at the time. As a result, multiple entities may duplicatively execute the same or similar operations, such as user authentication or fraud checks. Both the sending of messages back and forth between the entities and the duplicative operations can result in computational and temporal inefficiencies.

Embodiments of the disclosure address these and other problems individually and collectively.

### BRIEF SUMMARY

Embodiments of the disclosure include methods as well as systems for managing a transaction state object for executing steps in a transaction in a unified and efficient manner.

One embodiment of the disclosure is directed to a method comprising: receiving, by a server computer from a first client computer, of a plurality of client computers, a transaction state object indicating that a transaction has been initiated; transmitting, by the server computer to a first subset of the plurality of client computers, a notification that the transaction has been initiated; receiving, from a second client computer, of the plurality of client computers, a first modification to the transaction state object indicating that a first step in the transaction has been executed; transmitting, by the server computer to a second subset of the plurality of client computers, a notification that the first step in the transaction has been executed; receiving, by the server computer from a third client computer, of the plurality of client computers, a second modification to the transaction state object indicating that a second step in the transaction has been executed; and transmitting, by the server computer to a third subset of the plurality of client computers, a notification that the second step in the transaction has been executed.

Another embodiment of the disclosure is directed to a system comprising a server computer programmed to perform the above-noted method.

Another embodiment of the disclosure is directed to a method comprising: receiving, by a client computer from a server computer, a notification that a transaction has been initiated; responsive to the notification, executing, by the client computer, a first step in the transaction; modifying, by the client computer, a transaction state object to indicate that the first step in the transaction has been executed, wherein the transaction state object is managed by the server computer; receiving, by the client computer from the server computer, a notification that a second step in the transaction has been executed.

Another embodiment of the disclosure is directed to an system comprising a client computer programmed to perform the above-noted method.

Further details regarding various embodiments can be found in the Detailed Description and the Figures.

### BRIEF DESCRIPTION OF THE DRAWINGS

The example embodiment(s) of the present disclosure are illustrated by way of example, and not in way by limitation, in the figures of the accompanying drawings and in which like reference numerals refer to similar elements and in which:

FIG. 1 shows a block diagram of a system according to one or more embodiments.

FIG. 2 shows a block diagram of a server computer according to one or more embodiments.

FIG. 3 shows an example of a transaction state object according to one or more embodiments.

FIGS. 4A-4D show example operations for managing a transaction state object according to one or more embodiments.

FIG. 5 shows a flow diagram illustrating operations for managing a transaction state object according to one or more embodiments.

FIG. 6 shows a flow diagram illustrating client-side operations for updating a transaction state object according to one or more embodiments.

While each of the figures illustrates a particular embodiment for purposes of illustrating a clear example, other embodiments may omit, add to, reorder, and/or modify any of the elements shown in the figures.

### DETAILED DESCRIPTION

### I. Definitions

Prior to discussing various embodiments, some terms can be described in further detail.

“Transaction data” or “transaction details” may refer to information associated with a transaction. For example, transaction data may include one or more of an authorized amount (e.g., transaction amount, item value, etc.), other amount, terminal country code, terminal verification results, transaction currency code, transaction date, transaction type (e.g., card-present transaction, card-not-present transaction, high value transaction, low value transaction, local transaction, international transaction, etc.), an unpredictable number, application interchange profile (AIP), application transaction counter (ATC), issuer application data (IAD), etc.

A “resource provider” may be an entity that can provide a resource such as goods, services, information, and/or access. Examples of resource providers includes merchants, data providers, transit agencies, governmental entities, venue and dwelling operators, etc. A resource provider may operate a resource provider computer.

A “merchant” may typically be an entity that engages in transactions and can sell goods or services, or provide access to goods or services.

An “authorizing entity” may be an entity that authorizes a request. Examples of an authorizing entity may be an issuer, a governmental agency, a document repository, an access administrator, etc. An authorizing entity may operate an authorization computer.

An “issuer” may typically refer to a business entity (e.g., a bank) that maintains an account for a user. An issuer may also issue payment credentials stored on a user device, such as a cellular telephone, smart card, tablet, or laptop to the consumer.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

“Authorization processing” or “authorization operations” may include at least determining whether to authorize a transaction. Authorization processing may be executed responsive to receiving a notification that a prior step in a transaction has been completed. Alternatively, or additionally, authorization processing may include generating and sending an authorization request message and/or authorization response message.

“Pre-authorization” or “pre-authorization operations” may include validation, queuing, and/or messaging operations. Pre-authorization operations may include validating transaction data. Pre-authorization operations may include placing a transaction in que for authorization.

“Capture” or “capture operations” may include capturing funds based on an initial authorization. Capture operations may include converting an authorized transaction into an invoicable transaction when goods or services are shipped or rendered. Capture may be executed in direct association with authorization. As an example, a payment of $3.00 for a cup of coffee is authorized, and the $3.00 is immediately captured. Alternatively, capture may be executed at a later time. As an example, an online merchant pre-authorizes a transaction of $50. When the goods are shipped, the online merchant captures the $50.

“Settlement” or “settlement operations” may include submitting an approved transaction for payment. Settlement operations may include transmitting transaction data to an authorizing entity such as an issuer. Settlement may occur in batches, e.g., at the end of a business day.

“Funding” or “funding operations” may include transferring funds to an account. Funding may include transmitting an authorized amount to a merchant in association with a transaction.

As used herein, a “notification” may include a message that can be sent to an entity to provide information to the entity, such as a status associated with an event. The notification may include additional information about the event such as a time, date, a description of the event, participants of the event, etc. In some embodiments, a notification or notification message may inform an entity that the entity should perform one or more operations in association with an event.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “key” may refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include a cryptographic key that that forms a public key of a public/private key pair. The public key may be designed to be shared (e.g., transmitted between entities) and may be configured such that any information encrypted with the public key may only be decrypted using a private key associated with the public key.

A “private key” may include a cryptographic key that forms a private key of a public/private key pair. A private key may be used to decrypt data encrypted with a public key.

### II. Systems

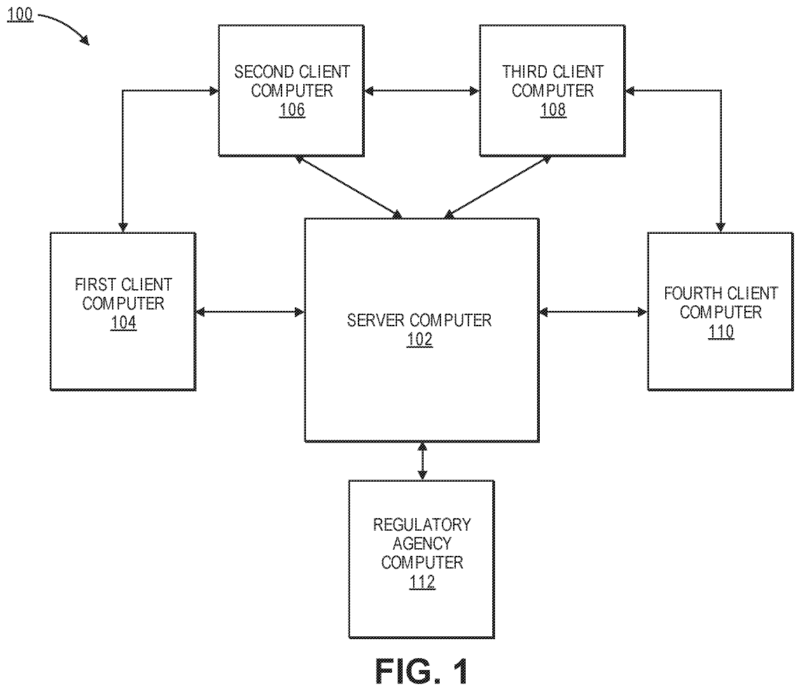

FIG. 1 shows a system 100 comprising a number of components according to some embodiments. System 100 illustrates only one of many possible arrangements of components configured to execute the programming described herein. Other arrangements may include fewer or different components, and the division of work between the components may vary depending on the arrangement.

The system illustrated in FIG. 1 may comprise a server computer 102 communicatively coupled to a plurality of client computers. The plurality of client computers may include a first client computer 104, a second client computer 106, a third client computer 108, and a fourth client computer 110. The system may further comprise a regulatory agency computer 112. The components of the system 100 may all be in operative communication with each other through a communication network.

The communication network may include any suitable communication medium. The communication network may be one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Message between the entities, providers, networks, and devices illustrated in FIG. 1 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

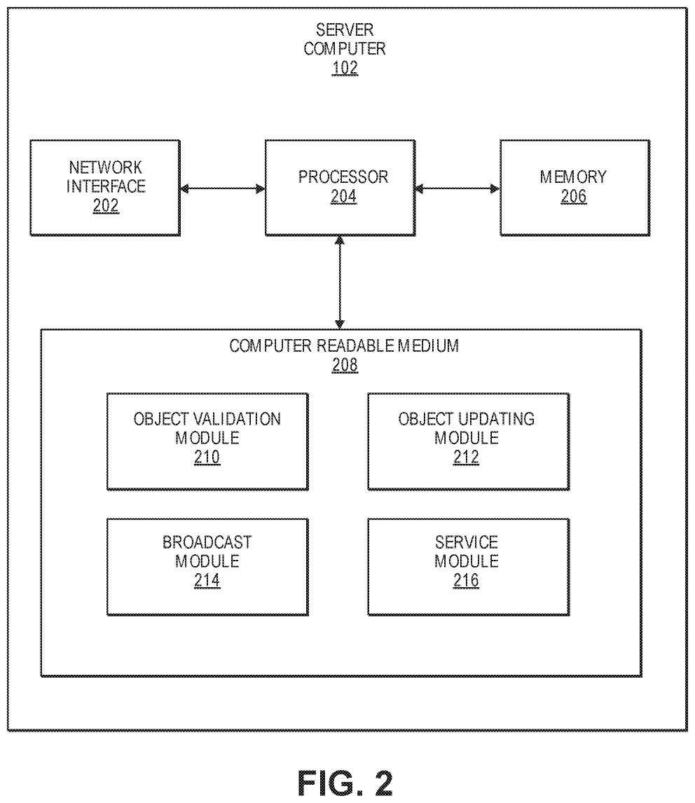

The server computer 102 may include functionality to manage a transaction state object, as further detailed with respect to FIGS. 2-6.

The server computer 102 may be further configured to provide authorization services and clearing-and-settlement services for payment transactions. The server computer 102 may include data processing subsystems, networks, and operations used to support and deliver authorization services, exception file services, and clearing and settlement services. An example of a payment processing network may include VisaNet™. Payment processing networks such as VisaNet™ are able to process credit card transactions, debit card transactions, and other types of commercial transactions. VisaNet™, in particular, includes a Visa Integrated Payments (VIP) system which processes authorization requests and a Base II system which performs clearing and settlement services. Furthermore, the payment processing network may use any suitable wired or wireless telecommunications network, including the Internet.

The first client computer 104 may be associated with a merchant. The first client computer 104 may, as examples, be a Point-of-Sale (POS) terminal at a merchant location or a remote server computer that operates a web site operated by the merchant. The first client computer 104 may include functionality to create a transaction state object. The first client computer 104 may include functionality to transmit the transaction state object to the server computer 102.

The second client computer 106 may be associated with a gateway. As used herein, a “gateway” can be any entity that provides services in support of electronic payment transactions. In some embodiments, such services can include message forwarding, pre-authorization operations, fraud prevention services, and/or capture operations. The second client computer 106 may include functionality to update the transaction state object.

The third client computer 108 may be a computer operated by an authorizing entity such as an account issuer, a transit agency, a secure location access provider, or a secure data access provider. Typically, an issuer is an entity (e.g., a bank) that issues and maintains an account of the user. The account may be a credit, debit, prepaid, or any other type of account. The third client computer 108 may include functionality to update the transaction state object.

The fourth client computer 110 may be operated by an acquirer. An acquirer is typically a system for an entity (e.g., a bank) that has a business relationship with a particular merchant, a wallet provider, or another entity. The fourth client computer 110 may issue and manage an account of the merchant. The fourth client computer 110 may include functionality to update the transaction state object.

In some embodiments, one or more of the client computers (e.g., the second client computer 106, third client computer 108, and/or the fourth client computer 110) includes a processor and a computer-readable medium coupled to the processor. The computer-readable medium may comprise code, executable by the processor, to implement a method comprising: receiving, by a client computer from a server computer, a notification that a transaction has been initiated; responsive to the notification, executing, by the client computer, a first step in the transaction; modifying, by the client computer, a transaction state object to indicate that the first step in the transaction has been executed, wherein the transaction state object is managed by the server computer; and receiving, by the client computer from the server computer, a notification that a second step in the transaction has been executed.

The regulatory agency computer 112 may be operated by a regulatory agency. The regulatory agency computer 112 may be configured to monitor transactions in real time. The regulatory agency computer 112 may further be configured to add metadata instructions to the transaction state object. The metadata instructions may affect the flow of the transaction. For example, based on the metadata instructions, payment processing by one of the client computers may be stopped or postponed. The regulatory agency computer 112 may cause a client computer to stop a transaction based on regulatory rules. For example, the regulatory agency computer 112 may prevent one or more client computers from executing one or more steps in a transaction, upon detecting transaction details (e.g. a payment transaction over $100,000 in cash across borders) that indicate a potential regulatory violation.

FIG. 2 shows a detailed view of the server computer 102. The server computer 102 may include a processor 204 operatively coupled to a network interface 202, a memory 206, and a computer-readable medium 208.

The network interface 202 can be configured to connect to one or more communication networks to allow the server computer 102 to communicate with other entities such as the first client computer 104, the second client computer 106, etc.

The processor 204 may be implemented as one or more integrated circuits (e.g., one or more single core or multicore microprocessors and/or microcontrollers). The processor 204 may be used to control the operation of the server computer 102. The processor 204 can execute a variety of programs in response to program code or computer-readable code stored in memory 206. The processor 204 may include functionality to maintain multiple concurrently executing programs or processes.

The memory 206 may be implemented using any combination of any number of non-volatile memories (e.g., flash memory) and volatile memories (e.g., DRAM, SRAM), or any other non-transitory storage medium, or a combination of media.

The computer-readable medium 208 may comprise one or more non-transitory media for storage and/or transmission. Suitable media include, as examples, a random access memory (RAM), a read only memory (ROM), a magnetic medium such as a hard-drive or a floppy disk, or an optical medium such as a compact disk (CD) or DVD (digital versatile disk), flash memory, and the like. The computer-readable medium 208 may be any combination of such storage or transmission devices.

The computer-readable medium 208 may comprise software code stored as a series of instructions or commands The computer-readable medium 208 may comprise an object validation module 210, an object updating module 212, a broadcast module 214, and a service module 216.

In some embodiments, the computer-readable medium 208 comprises code, executable by the processor 204, to implement a method comprising: receiving, by a server computer from a first client computer, of a plurality of client computers, a transaction state object indicating that a transaction has been initiated; transmitting, by the server computer to a first subset of the plurality of client computers, a notification that the transaction has been initiated; receiving, from a second client computer, of the plurality of client computers, a first modification to the transaction state object indicating that a first step in the transaction has been executed; transmitting, by the server computer to a second subset of the plurality of client computers, a notification that the first step in the transaction has been executed; receiving, by the server computer from a third client computer, of the plurality of client computers, a second modification to the transaction state object indicating that a second step in the transaction has been executed; and transmitting, by the server computer to a third subset of the plurality of client computers, a notification that the second step in the transaction has been executed.

The object validation module 210 may comprise code for validating a received transaction state object. The object validation module 210 may validate a transaction state object via, as examples, one or more of a sanity check, a regulatory check, or a fraud risk check. The object validation module 210 may further be configured to validate a change to an existing transaction state object.

The broadcast module 214 may comprise code for transmitting a notification to one or more computers. The broadcast module 214 may further include functionality to identify a subset of the client computers (104, 106, 108, 110) and/or the regulatory agency computer 112 to which to transmit a particular notification.

The service module 216 may comprise code for executing one or more services in association with the transaction. As examples, the service module 216 may be configured to execute fraud detection operations and/fraud prevention operations. As another example the service module 216 may be configured to execute regulatory check operations, such as an Office of Foreign Assets Control (OFAC) check. As another example, the service module 216 may be configured to execute fee-related operations, such as determining fees associated with the transaction.

The object updating module 212 may comprise code for updating a transaction state object. The object updating module 212 may update the transaction state object, based on functions executed by the service module 216. As an example, the object updating module 212 may add a designation, to the transaction state object, specifying fees incurred. As another example, the object updating module 212 may add a designation to the transaction state object specifying that a regulatory check has been passed. Alternatively, or additionally, the object updating module 212 may update the transaction state object based on functions executed by one or more client computers. As an example, the second client computer 106 may transmit a notification to the server computer 102 indicating that the second client computer has executed authentication operations. Responsive to the notification, the server computer 102 may modify the transaction state object with a tag indicating that authentication has been executed.

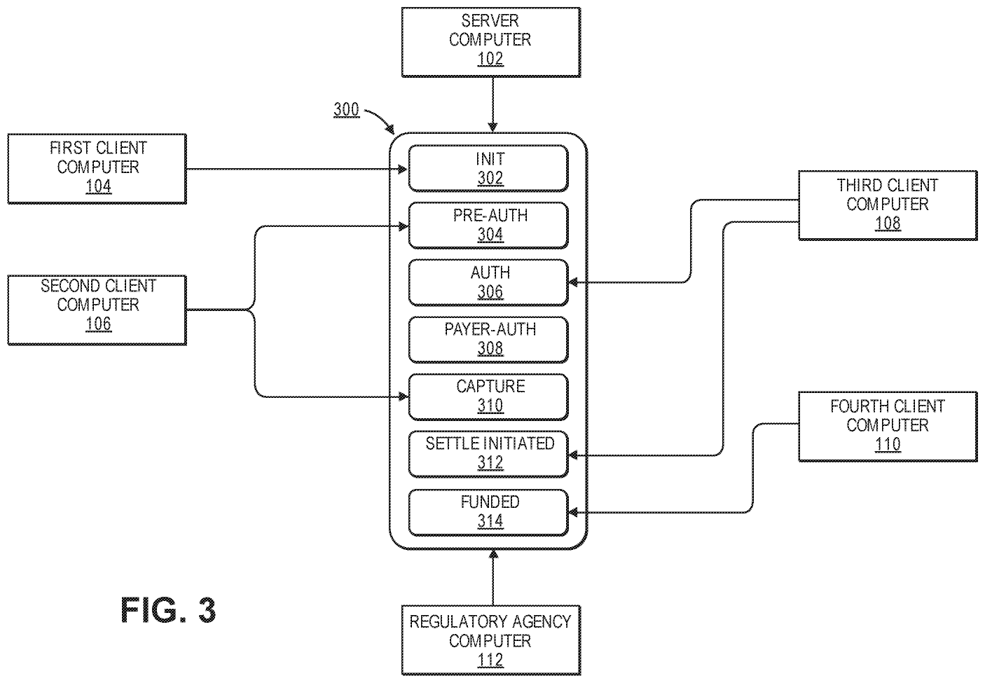

FIG. 3 illustrates an example of a transaction state object 300 according to one or more embodiments. Each of the server computer 102, first client computer 104, second client computer 106, third client computer 108, fourth client computer 110, and regulatory agency computer 112 may be granted permissions to modify the transaction state object 300. Each of the server computer 102, first client computer 104, second client computer 106, third client computer 108, fourth client computer 110, and regulatory agency computer 112 may further be granted permissions to determine the state of the transaction state object 300 at a given time.

The transaction state object 300 may be associated with a particular transaction. The server computer 102 may manage a plurality of transaction state objects associated with a plurality of different transactions. Each transaction state object 300 may be assigned a transaction identification number (ID) or other identifier to distinguish the various transaction state objects.

The transaction state object 300 may be associated with one or more states. The states may include INIT 302, PRE-AUTH 304, AUTH 306, PAYER-AUTH 308, CAPTURE 310, SETTLE INITIATED 312, AND FUNDED 314. Each time one of the computers in system 100 executes a step in a transaction, the corresponding computer may update the transaction state object to a new state representing the executed step.

The first client computer 104 may generate the transaction state object 300, with an initial flag INIT 302, indicating that the transaction has been initiated. The first client computer 104 may be a resource provider computer such as a merchant computer, which initiates a transaction. Based on initiating the transaction, the first client computer 104 may generate the transaction state object in the initial state.

The second client computer 106 may execute pre-authorization operations. When a pre-authorization operation is executed, the second client computer 106 may modify the transaction state object 300 by adding a PRE-AUTH flag 304, indicating that pre-authorization has been executed. As shown in FIG. 3, the transaction state object 300 may include multiple flags to denote multiple steps in the transaction that have been executed. The second client computer 106 may further execute capture operations. When a capture operation is executed, the second client computer 106 may modify the transaction state object 300 by adding a CAPTURE flag 310, indicating that capture has been executed.

The third client computer 108 may execute authorization operations. When an authorization operation is executed, the second client computer 106 may modify the transaction state object by adding an AUTH flag 306, indicating that authorization has been executed. The third client computer 108 may further execute settlement operations. When a settlement operation is executed, the third client computer 108 may modify the transaction state object 300 by adding a SETTLE INITIATED flag 312, indicating that settlement has been initiated.

The fourth client computer 110 may execute funding operations. When a funding operation is executed, the fourth client computer 110 may modify the transaction state object by adding a FUNDED flag 314, indicating that funding operations have been executed.

The server computer 102 may execute various services. Upon executing a service, the server computer 102 may modify the transaction state object 300 by adding an appropriate flag. For example, the server computer 102 may execute authorization operations and add an AUTH flag 306 to the transaction state object 300. As another example, the server computer 102 may execute a currency conversion operation and add a CONV flag (not pictured) to the transaction state object 300.

The server computer 102 may transmit a notification regarding the current state of the transaction state object 300 to one or more of the computers based on validating and/or detecting a state change. Alternatively, or additionally, the first client computer 104, second client computer 106, third client computer 108, fourth client computer 110, and regulatory agency computer 112 may query the server computer 102 to identify a current state of the transaction state object 300.

Responsive to receiving the query, the server computer 102 may transmit state information specifying the state of the transaction state object.

### III. Methods

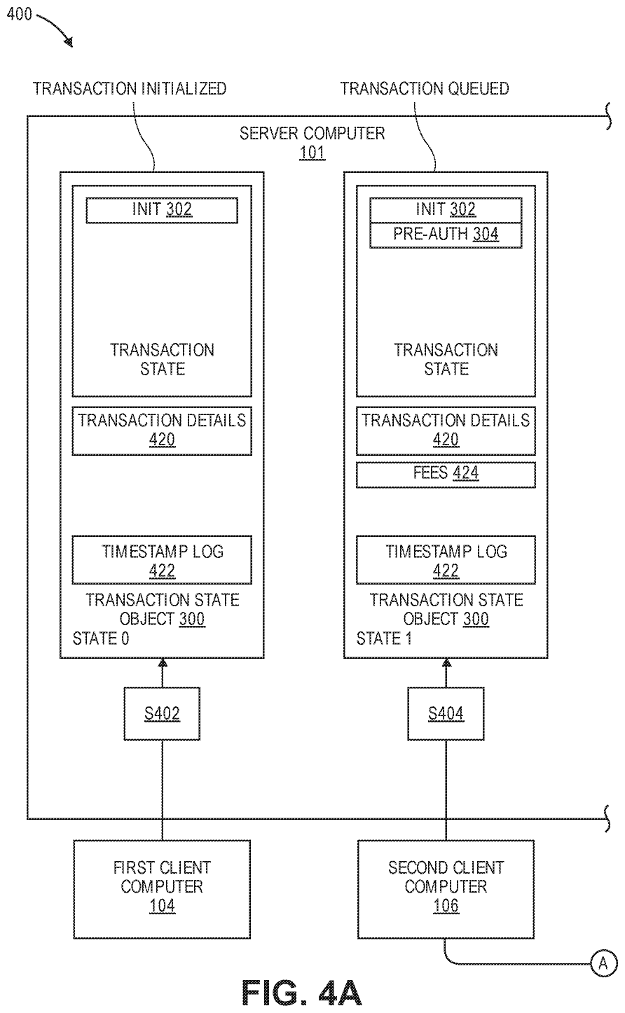

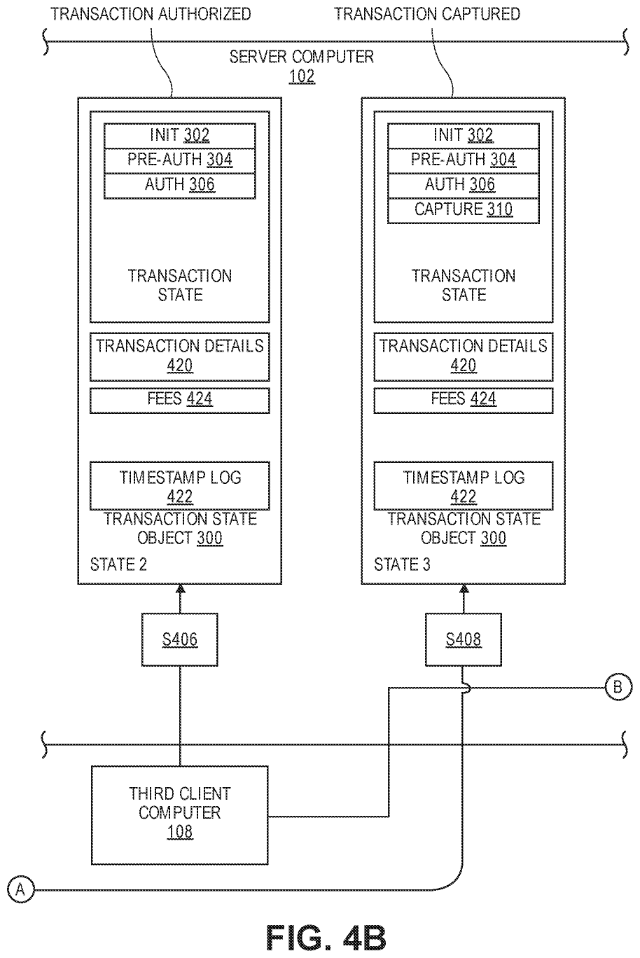

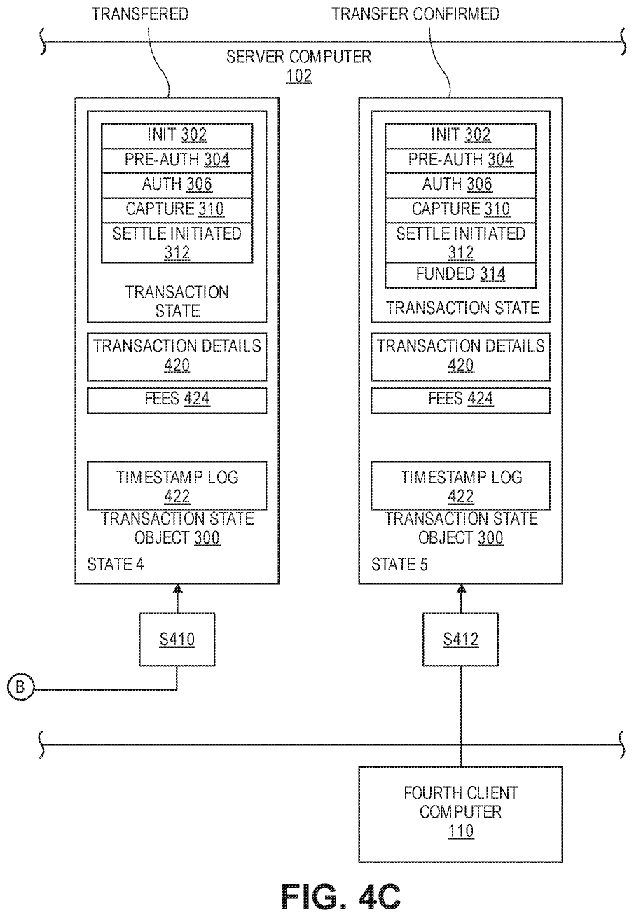

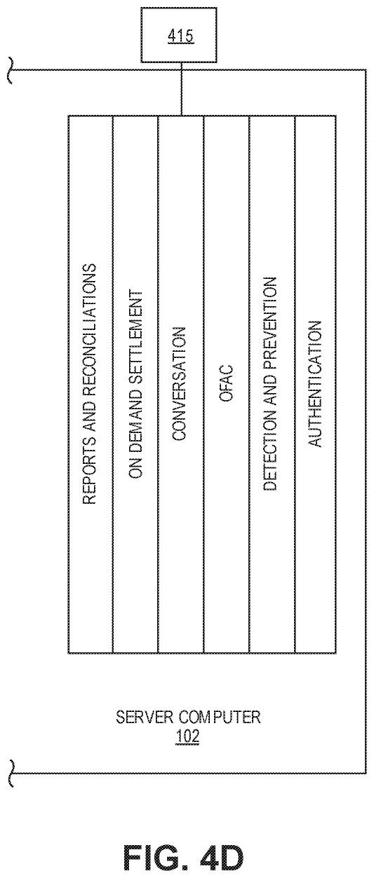

A method is described with respect to FIGS. 4A-4D. Before step S402, the first client computer 104 may initialize a transaction. For example, the first client computer 104 may receive a user's credit card information for payment for a cup of coffee and forward transaction data to the server computer 102.

With reference to FIG. 4A, at step S402, the first client computer 104 may generate a transaction state object 300. The first client computer 104 may generate the transaction state object to be in an initial state (e.g., State 0). The first client computer 104 may generate the transaction state object 300 to include an INIT flag 302, which indicates that the transaction has been initiated. The first client computer 104 may further generate the transaction state object 300 to include transaction details 420. For example, the first client computer may generate the transaction state object to include a transaction amount and a payment account number. The transaction state object may further be generated to include a unique transaction ID (not pictured).

Additionally, the first client computer 104 may generate the transaction state object 300 to include a timestamp log 422 for tracking the time at which various steps in the transaction are executed. The timestamp log 422 may, as an example, initially specify a time at which the transaction was initiated.

Subsequent to generating the transaction state object, the first client computer 104 may transmit the transaction state object 300 to the server computer 102. For example, the first client computer 104 may push the transaction state object 300 to an Application Programming Interface (API) exposed by the server computer 102. Alternatively, or additionally, the first client computer 104 may push the transaction state object 300 via message bus for communication between the server computer 102, the client computers (104, 106, 108, 110) and/or the regulatory agency computer 112.

Alternatively, the server computer 102 may generate the transaction state object 300 based on receiving a notification from the first client computer 104. The first client computer 104 may transmit transaction data the server computer 102. In response, the server computer 102 may generate the transaction state object 300. In either case, the transaction state object is 300 stored to, and managed by, the server computer 102.

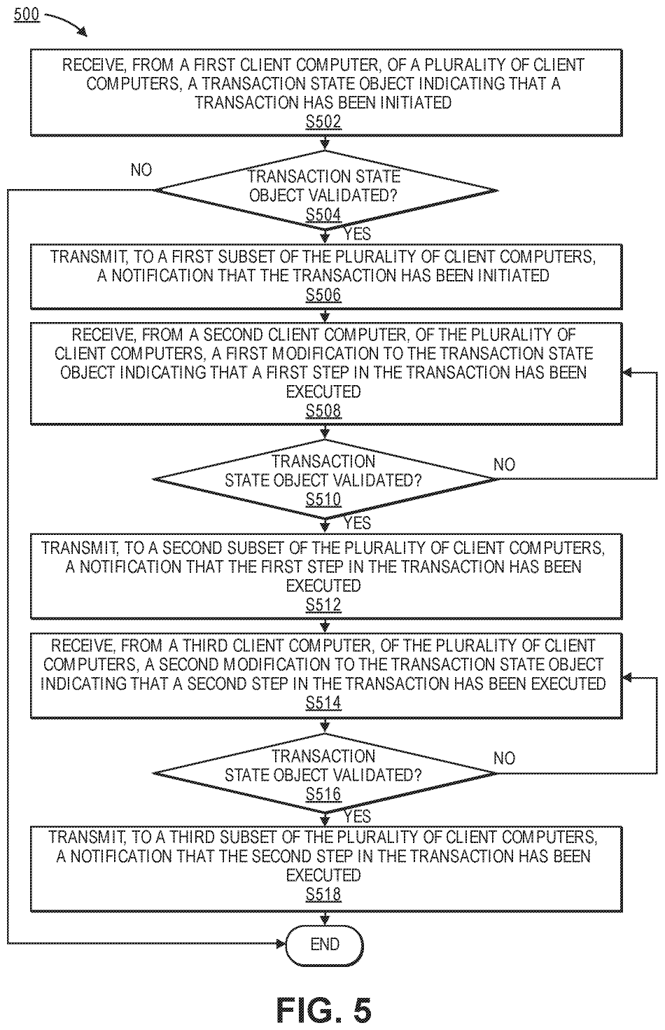

Upon receiving (or generating) the transaction state object 300, the server computer 102 may perform validation operations. If the transaction state object is validated, then the server computer 102 may transmit a notification to one or more client computers, as described further below with respect to FIG. 5.

Before step S404, the second client computer 106 may receive a notification from the server computer 102, indicating that the transaction has been initiated. Responsive to receiving the notification, the second client computer may execute a next step in the transaction. As an example, the second client computer 106 may execute pre-authorization operations, such as placing the transaction in que for authorization.

At step S404, the second client computer 106 may add a PRE-AUTH flag 304 to the transaction state object 300. The second client computer 106 may further modify the transaction state object 300 to update the timestamp log (e.g., to reflect a time at which the transaction is put in que for authorization). The second client computer 106 may further modify the transaction state object 300 to include additional transaction details 420. The second client computer may further modify the transaction state object 300 to change the state (e.g., from State 0 to State 1).

Upon detecting changes to the transaction state object 300, the server computer 102 may perform validation operations. If the transaction state object is validated, then the server computer 102 may notify one or more client computers of the change in state.

The server computer 102 may further modify the transaction state object 300 to specify fees 424. For example, the server computer 102 may perform a service for which fees are assessed. The server computer may add data characterizing the fees to the transaction state object 300. Alternatively, or additionally, the server computer, or one of the client computers, may modify the transaction state object 300 to specify fees charged in association with step(s) performed by a client computer.

Referring to FIG. 4B, before step S406, the third client computer 108 may receive a notification from the server computer 102, indicating that the transaction state object 300 has been updated. Responsive to receiving the notification, the third client computer 108 may execute a next step in the transaction. As an example, the third client computer 108 may execute authorization operations.

At step S406, the third client computer 108 may add an AUTH flag 306 to the transaction state object, to indicate that authorization operations have been executed. The third client computer 108 may further modify the transaction state object to update the timestamp log 422, transaction details 420, and/or fees 424. The third client computer 108 may further modify the transaction state object 300 to change the state (e.g., from State 1 to State 2).

Upon detecting changes to the transaction state object 300, the server computer 102 may perform validation operations. If the transaction state object is validated, then the server computer 102 may notify one or more client computers of the change in state.

Before step S408, the second client computer 106 may receive a notification from the server computer 102, indicating that the transaction state object 300 has been updated. Responsive to receiving the notification, second client computer 106 may execute a next step in the transaction. As an example, the second client computer 106 may execute capture operations.

At step S408, the second client computer 106 may add a CAPTURE flag 310 to the transaction state object, to indicate that capture operations have been executed. The second client computer 106 may further modify the transaction state object to update the timestamp log 422, transaction details 420, and/or fees 424. The second client computer 106 may further modify the transaction state object 300 to change the state (e.g., from State 2 to State 3).

Upon detecting changes to the transaction state object 300, the server computer 102 may perform validation operations. If the transaction state object is validated, then the server computer 102 may notify one or more client computers of the change in state.

Referring to FIG. 4C, before step S410, the third client computer 108 may receive the notification from the server computer 102, indicating that the transaction state object 300 has been updated. Responsive to receiving the notification, third client computer 108 may execute a next step in the transaction. As an example, the third client computer 108 may execute settlement operations, such as transmitting transaction details about an approved transaction to an issuing bank.

At step S410, the third client computer 108 may add a SETTLE INITIATED flag 312 to the transaction state object, to indicate that settlement operations have been executed. The third client computer 108 may further modify the transaction state object to update the timestamp log 422, transaction details 420, and/or fees 424. The third client computer 108 may further modify the transaction state object 300 to change the state (e.g., from State 3 to State 4).

Upon detecting changes to the transaction state object 300, the server computer 102 may perform validation operations. If the transaction state object is validated, then the server computer 102 may notify one or more client computers of the change in state.

Before step S412, the fourth client computer 110 may receive the notification from the server computer 102, indicating that the transaction state object 300 has been updated. Responsive to receiving the notification, the fourth client computer 110 may execute the next step in the transaction. As an example, the fourth client computer 110 may execute funding operations such as transferring funds for an approved transaction from a purchaser's account to an account of a merchant.

At step S412, the fourth client computer 110 may add a FUNDED flag 314 to the transaction state object, to indicate that funding operations have been executed. The fourth client computer 110 may further modify the transaction state object to update the timestamp log 422, transaction details 420, and/or fees 424. The fourth client computer 110 may further modify the transaction state object 300 to change the state (e.g., from State 4 to State 5).

Upon detecting changes to the transaction state object 300, the server computer 102 may perform validation operations. If the transaction state object is validated, then the server computer 102 may notify one or more client computers of the change in state.

With reference to FIG. 4D, the server computer 102 may provide one or more additional services 415. The services 415 may include authentication operations. Authentication operations may include verifying a user associated with a transaction based on characteristics of the user and/or the transaction itself. The services 415 may include fraud detection operations and/or fraud prevention operations. Fraud detection and/or prevention operations may include analyzing transaction data in comparison with previous transactions which have been found to be fraudulent. The services 415 may include regulatory checks (e.g., an OFAC check). The services 415 may include reports and reconciliations. As an example, the server computer 102 may generate a report comprising transaction details corresponding to a set of transactions, for a merchant to use in reconciling the merchant's transaction records with the transaction records of the server computer. The services 415 may further include currency conversion operations and/or on-demand settlement operations. These services 415 may or may not result in the server computer 102 modifying the transaction state object 300 to reflect the services performed.

FIG. 5 depicts a flow diagram illustrating an example process for managing a transaction state object in accordance with at least some embodiments. Process 500 may be performed by a server computer as depicted in FIG. 1.

Initially, the server computer may issue public keys to one or more client computers. The public keys may be used, along with access rules, to control the client computers' access to the transaction state object. The access rules may control an ability to modify and/or view the transaction state object. For example, the server computer may issue a first public key to the first client computer. Using the first public key, the first client computer may generate a transaction state object in State 0. The server computer may issue a second public key to the second client computer. Using the second public key, the second client computer may add a PRE-AUTH flag to the transaction state object and cause the transaction state object to transition from State 0 to State 1. Alternatively, or additionally, the public keys may control the client computers' ability to view the transaction state object (i.e., by inclusion in one or more of the subsets of the plurality of client computers for receiving a notification, further described below). The server computer may further issue a separate public key to the regulatory agency computer, which allows the regulatory agency computer to monitor a transaction and/or add metadata instructions to the transaction state object.

Before step S502, the first client computer may initiate a transaction. The first client computer may generate a transaction state object, in State 0, with the INIT flag. The first client computer may transmit the transaction state object to the server computer. Alternatively, the first client computer may notify the server computer that the transaction has been initiated, and the server computer may generate the transaction state object in State 0 (in which case steps S502 and S504 may be omitted).

At step S502, the server computer receives, from the first client computer, a transaction state object indicating that a transaction has been initiated. The first client computer may push the transaction state object to the server computer (e.g., via a push to an API and/or message bus associated with the server computer).

At step S504, the server computer validates the transaction state object. The server computer may execute one or more validation checks to validate the transaction state object. As an example, the server computer may execute a sanity check to confirm that the transaction state object does not contain any errors. As another example, the server computer may execute a regulatory check, such as an OFAC check, to identify any regulatory violations. As another example, the server computer may execute a risk check, to determine whether any transaction data indicates a likelihood of fraud.

If the transaction state is not validated, then the server computer may decline to generate the transaction state object. The server computer may stop the transaction and prohibit any further modification to the transaction state object. If the transaction state is validated, then the server computer may proceed to step S506.

At step S506, the server computer transmits, to a first subset of the plurality of client computers, a notification that the transaction has been initiated. The server computer may initially determine the first subset of the plurality of client computers based on stored access rules. As an example, the server computer may only broadcast the INIT status to the second client computer, as the second client computer is the client computer that executes the next step after transaction initiation. As another example, the server computer may broadcast the INIT status to all client computers, to inform the client computers that the transaction has been initiated. Alternatively, or additionally, some of the client computers may subscribe to one or more notifications. The server computer may select the first subset of the plurality of client computers based on the subscriptions.

The server computer may transmit the notification to the first subset of the plurality of client computers by a push operation. The server computer may push a notification to one or more client computers via an API (e.g., a message bus). The notification may comprise a state of the transaction (e.g., State 0 and/or INIT). The notification may comprise a message that an action associated with the transaction is due from the recipient (e.g., notifying the first client computer that the first client computer should now perform pre-authorization operations). The notification may further comprise the transaction state object, in whole or in part (e.g., the transaction data, the fees, and/or the whole transaction state object).

At step S508, the server computer receives, from the second client computer, a first modification to the transaction state object indicating that a first step in the transaction has been executed. As an example, the server computer may receive a notification from a gateway computer indicating that the gateway computer has added a PRE-AUTH flag to indicate that pre-authorization operations have been executed. As another example, the server computer may receive a notification from an authorizing computer indicating that the authorizing computer has added an AUTH flag to indicate that authorization operation shave been executed.

At step S510, the server computer validates the transaction state object. The server computer may execute one or more validation checks, as described above with respect to step S504. If the transaction state object is not validated (e.g., validation is failed), then the server computer may decline to modify the transaction state object. The server computer may continue to monitor for additional modifications to the transaction state object. Alternatively, the server computer may stop the transaction and prohibit any further modification to the transaction state object. If the transaction state object is validated, then the server computer may proceed to step S512.

At step S512, the server computer transmits, to a second subset of the plurality of client computers, a notification that the first step in the transaction has been executed. The server computer may initially determine the second subset of the plurality of client computers based on stored rules. The second subset of the plurality of client computers may be different from, or the same as, the first subset of the plurality of client computers. As an example, the server computer may broadcast the INIT status to a first subset comprising the first, second and third client computers. The server computer may broadcast the AUTH status to a second subset of the plurality of client computers comprising the second client computer, the third client computer, and the fourth client computer. As another example, the server computer may transmit both notifications to all the client computers.

At step S514, the server computer receives, from the third client computer, a second modification to the transaction state object indicating that a second step in the transaction has been executed. As an example, the server computer may receive a notification from an authorizing computer indicating that the authorizing computer has added an AUTH flag to indicate that authorization operations have been executed. As another example, the server computer may receive a notification from a gateway computer indicating that the gateway computer has added a CAPTURE flag to indicate that capture operations have been executed.

At step S516, the server computer validates the transaction state object. The server computer may execute one or more validation checks, as described above with respect to step S510.

At step S518, the server computer transmits, to a third subset of the plurality of client computers, a notification that the second step in the transaction has been executed. The server computer may initially determine the third subset of the plurality of client computers based on stored rules. The third subset of the plurality of client computers may be different from, or the same as, the first subset of the plurality of client computers and/or the second subset of the plurality of client computers.

The server computer may manage the transaction state object across additional states. For example, the server computer may receive, from a fourth client computer, of the plurality of client computers, a third modification to the transaction state object indicating that a third step in the transaction has been executed. The server computer may transmit, to a fourth subset of the plurality of client computers, a notification that the third step in the transaction has been executed.

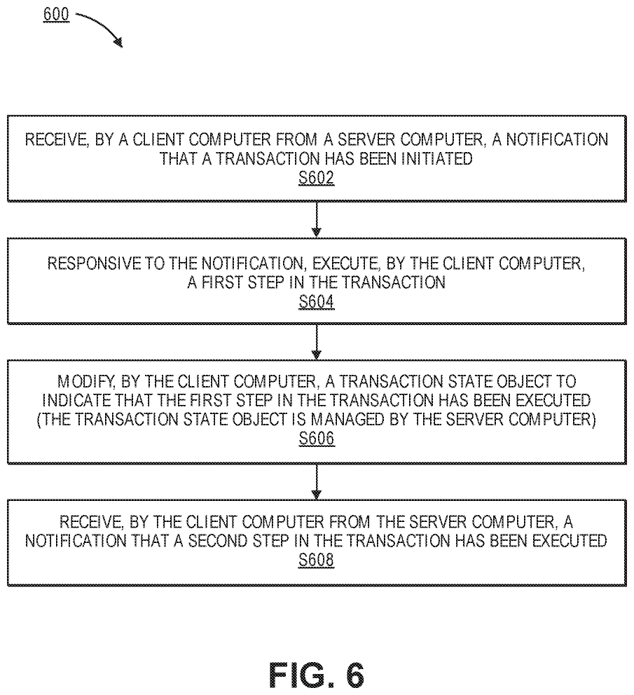

FIG. 6 depicts a flow diagram illustrating an example process for updating a transaction state object in accordance with at least some embodiments. Process 600 may be performed by a client computer (e.g., the second client computer, third client computer, or fourth client computer) as depicted in FIG. 1.

Before step S602, the first client computer may initiate a transaction. The first client computer may generate a transaction state object, in State 0, with the INIT flag. The first client computer may transmit the transaction state object to the server computer. The server computer may transmit, to one or more client computers, a notification that the transaction has been initiated.

At step S602, the client computer receives, from the server computer, a notification that the transaction has been initiated. The client computer may, for example, receive a message from the server computer indicating that a new transaction state object has been generated, with means for accessing the transaction state object. Alternatively, or additionally, the notification may indicate that the client computer should execute a next step in the transaction.

At step S604, the client computer executes a first step in the transaction, responsive to the notification. The client computer may execute a first step such as authentication, authorization, or pre-authorization operations, responsive to receiving the notification that the transaction has been initiated.

At step S606, the client computer modifies the transaction state object to indicate that the first step in the transaction has been executed. The transaction state object may be managed by the server computer. Thus, the client computer may require permissions to modify the transaction state object (i.e., via a public key previously issued to the client computer by the server computer).

The client computer may modify the transaction state object by adding an appropriate flag, such as a PRE-AUTH flag or AUTH flag, to denote the operation executed at step S604. The client computer may further modify the transaction state object to update the timestamp log, transaction details, and/or fees. The client computer may further modify the transaction state object to change the state (e.g., from State 0 to State 1).

Subsequent to step S606, the server computer may transmit a notification to one or more client computers that the first step in the transaction has been executed. The client computers receiving the notification may or may not include the client computer executing steps S602-S608. Responsive to receiving the notification that the first step in the transaction has been executed, another client computer may execute a second step in the transaction and modify the transaction state object, in a similar fashion to steps S604-S606. The server computer may then transmit a notification, to one or more client computers, that the second step in the transaction has been executed.

At step S608, the client computer may receive, from the server computer, a notification that the second step in the transaction has been executed. The client computer may receive the notification that the second step in the transaction has been executed in a substantially similar fashion to receiving the notification that the transaction has been initiated at step S602.

As a non-limiting example, the server computer and one or more client computers may manage a transaction state object using the following logic. The server computer may initially create a global system which allows the client computers to subscribe to receive notifications regarding modifications to the transaction state object.

A first client computer, associated with a merchant, initiates a transaction. The first client computer creates a transaction state object using the following logic:

transactionProcessing ( ) {

/* Merchant creates transaction state object as Init */

Transaction_state.create( );
Transaction_state.setStatus (INIT);
Transaction_state.setTransactionData(...);

MessageBus.push(Transaction_state);

/* Merchant pushes transaction state object to the

Message Bus */

}

The server computer validates and broadcasts the transaction state object using the following logic:

Transaction_state.validate(

{ /* Server computer runs
different validations (Basic sanity, OFAC check, Risk etc.) when
receiving the Transaction_state message */

run_Basic_Sanity( );

run_OFAC_Check( );

run_Risk_Rules( );

.

.
.

}

)

If (Transaction_state == State_Authorized_entity 1)

{ /* Server computer routes the Transaction_state
message to an Entity List( 1 or many) based on the state of the
Transaction_state object */

MessageBus.Push (Transaction_state,

EntityList1);

} else If (Transaction_state == State_Authorized_entity 2) {

MessageBus.Push (Transaction

_State, EntityList2);

}

.
.
.
} else If (Transaction_state == State_Authorized_entity
N)
{

MessageBus.Push (Transaction

_State, EntityListN);

}

A second client computer updates the transaction state object using the following logic:

onTransactionMessageRecevied (Transaction_State)

| | |
|---|---|
| { | /* An Entity (Processor, Issuer, Acquirer etc.) receives a |

Transaction_state object and adorns it for next level of processing */

If (Transaction _State == Status 1 ) {

Transaction_State.adorn(NEXT_STATE);

} else if (Transaction_State == Status 2) {

Message_State.adorn (REJECT);

}
.
.
.
MessageBus.push(Transaction _state)
}

The teachings of this disclosure have a number of advantages. Efficiency is gained by avoiding the duplication of processes by multiple entities. For example, fraud detection does not need to be repeated by multiple client computers, as the client computers can determine when a fraud check has been executed based on the transaction state object. Similarly, the client computers can avoid duplicative authentication operations by determining that authentication has been executed based on the transaction state object. The server computer may execute regulatory compliance checks, obviating the need for the client computers to perform regulatory compliance operations. These efficiencies could reduce 30-40% of computation costs by obviating the need for the entities in the system to execute common functions. These efficiencies may also result in lower electricity usage. Similarly, duplication of data is avoided, which reduces the cost of storage of data.

Some embodiments may increase the speed of a transaction substantially. By eliminating the need for a request/response model, the transaction continually moves forward, rather than pausing while the various entities await messages. Some embodiments lift processing speed for all entities uniformly, in contrast to prior systems, which are limited in speed to the slowest entity involved. Further, some embodiments provide a significant speed increase for end-to-end settlement. Traditionally, settlement may take days due to the need to reconcile data elements in disparate systems. With the teachings of this disclosure, there is a single source of truth in that each client computer can consult the same transaction state object to monitor the status of the transaction. Accordingly, settlement can happen in the order of minutes, rather than days.

Embodiments have a number of additional advantages. For example, some embodiments provide transparency, in that any entity can determine the transaction state at any time. Some embodiments ease the security of data at rest, by absolving different entities from having to safeguard data. This reduces the cost for all the entities involved. Some embodiments improve error recovery. In prior systems, error recovery may be difficult due to the request-response nature. With the teachings of this disclosure, any message can be retried to achieve the proper state.

Although examples are described in the context of payment, the methods described herein are applicable in other contexts. As an example, embodiments may be used manage a transaction state object for project management, to track each entity's completion of steps in a project. As another example, embodiments may be used to manage a transaction state object for admissions. The transaction state object may be updated by different parties when an application to attend an educational institution is received, when supporting documents are uploaded, when an interview is conducted, when an offer is extended, and when the offer is accepted or declined.

It should be understood that any of the embodiments be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices.

Such programs may also be encoded and transmitted using carrier signals adapted for transmission via wired, optical, and/or wireless networks conforming to a variety of protocols, including the Internet. As such, a computer-readable medium according to an embodiment may be created using a data signal encoded with such programs. Computer readable media encoded with the program code may be packaged with a compatible device or provided separately from other devices (e.g., via Internet download). Any such computer-readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the embodiments will become apparent to those skilled in the art upon review of the disclosure. The scope of the embodiments should, therefore, be determined not with reference to the above description, but instead should be determined with reference to the pending claims along with their full scope or equivalents.

One or more features from any embodiment may be combined with one or more features of any other embodiment without departing from the teachings of this disclosure.

As used herein, the use of “a,” “an,” or “the” is intended to mean “at least one,” unless specifically indicated to the contrary.

1. A method comprising:
receiving, by a server computer from a first client computer, of a plurality of client computers, a transaction state object indicating that a transaction has been initiated;
transmitting, by the server computer to a first subset of the plurality of client computers, a notification that the transaction has been initiated;
receiving, from a second client computer, of the plurality of client computers, a first modification to the transaction state object indicating that a first step in the transaction has been executed;
transmitting, by the server computer to a second subset of the plurality of client computers, a notification that the first step in the transaction has been executed;
receiving, by the server computer from a third client computer, of the plurality of client computers, a second modification to the transaction state object indicating that a second step in the transaction has been executed; and
transmitting, by the server computer to a third subset of the plurality of client computers, a notification that the second step in the transaction has been executed.

2. The method of claim 1, wherein the first client computer comprises a resource provider computer, the second client computer comprises a gateway computer, and the third client computer comprises an authorizing computer.

3. The method of claim 1, wherein the first step comprises pre-authorization operations and the second step comprises authorization operations.

4. The method of claim 1, further comprising:
receiving, from a fourth client computer, of the plurality of client computers, a third modification to the transaction state object indicating that a third step in the transaction has been executed; and
transmitting, by the server computer to a fourth subset of the plurality of client computers, a notification that the third step in the transaction has been executed.

5. The method of claim 4, wherein the third client computer comprises a transport computer.

6. The method of claim 1, further comprising granting public keys to each of the respective client computers, of the plurality of client computers, wherein the public keys control one or more of: an ability to modify the transaction state object, or inclusion in one or more of the subsets of the plurality of client computers.

7. The method of claim 1, further comprising granting a public key to a regulatory agency computer, wherein the public key controls one or more of: an ability to modify the transaction state object, or inclusion in one or more of the subsets of the plurality of client computers.

8. The method of claim 1, wherein the method further comprises executing, by the server computer, one or more of regulatory check operations or conversion operations.

9. The method of claim 1, wherein the method further comprises executing, by a client computer, of the plurality of client computers, authorization operations responsive to receiving a notification from the server computer.

10. The method of claim 1, further comprising:
receiving, by the server computer from a client computer, of the plurality of client computers, a query as to a state of the transaction state object; and
responsive to the query, transmitting, by the server computer to the client computer, state information specifying the state of the transaction state object.

11. A system comprising:
a server computer comprising:
a processor; and
a non-transitory computer-readable medium comprising code, executable by the processor, to implement a method comprising:
receiving, by the server computer from a first client computer, of a plurality of client computers, a transaction state object indicating that a transaction has been initiated;
transmitting, by the server computer to a first subset of the plurality of client computers, a notification that the transaction has been initiated;
receiving, from a second client computer, of the plurality of client computers, a first modification to the transaction state object indicating that a first step in the transaction has been executed;
transmitting, by the server computer to a second subset of the plurality of client computers, a notification that the first step in the transaction has been executed;
receiving, by the server computer from a third client computer, of the plurality of client computers, a second modification to the transaction state object indicating that a second step in the transaction has been executed; and
transmitting, by the server computer to a third subset of the plurality of client computers, a notification that the second step in the transaction has been executed.

12. The system of claim 11, wherein the first client computer comprises a resource provider computer, the second client computer comprises a gateway computer, and the third client computer comprises an authorizing computer.

13. The system of claim 11, wherein the first step comprises pre-authorization operations and the second step comprises authorization operations.

14. The system of claim 11, the method further comprising granting public keys to each of the respective client computers, of the plurality of client computers, wherein the public keys control one or more of: an ability to modify the transaction state object, or inclusion in one or more of the subsets of the plurality of client computers.

15. The system of claim 11, wherein the method further comprises executing, by the server computer, one or more of regulatory check operations or conversion operations.

16. A method comprising:
receiving, by a client computer from a server computer, a notification that a transaction has been initiated;
responsive to the notification, executing, by the client computer, a first step in the transaction;
modifying, by the client computer, a transaction state object to indicate that the first step in the transaction has been executed, wherein the transaction state object is managed by the server computer; and
receiving, by the client computer from the server computer, a notification that a second step in the transaction has been executed.

17. The method of claim 16, wherein the client computer comprises one or more of: a resource provider computer, a gateway computer, an authorizing computer, or a transport computer.

18. The method of claim 16, wherein the first step comprises pre-authorization operations and the second step comprises authorization operations.

19. The method of claim 16, wherein the client computer modifies the transaction state object and receives notifications based on access rules and a public key granted by the server computer.

20.-23. (canceled)

24. The system of claim 11, the method further comprising granting a public key to a regulatory agency computer, wherein the public key controls one or more of: an ability to modify the transaction state object, or inclusion in one or more of the subsets of the plurality of client computers.
